(19) United States
(12) Patent Application Publication
(10) Pub. No.: US 2013/0003381 A1
(43) Pub. Date: Jan. 3, 2013

(54) LIGHT EMITTING DEVICE

(75) Inventors: Hideki KOKUBU, Kiyosu-shi (JP); Kosei Fukui, Kiyosu-shi (JP); Toshimasa Hayashi, Kiyosu-shi (JP); Yukihiro Demukai, Kiyosu-shi (JP)

(73) Assignee: Toyoda Gosei Co., Ltd., Kiyosu-shi (JP)

(21) Appl. No.: 13/535,245

(22) Filed: Jun. 27, 2012

(30) Foreign Application Priority Data
Jun. 29, 2011 (JP) 2011-144906

(51) Int. Cl. F21V 21/00

(52) U.S. Cl. 362/249.14; 362/249.01

(57) ABSTRACT

A light emitting device comprises two or more light emitting elements, two or more lead frames electrically connected to the light emitting elements, and a case formed as a slender flat box shape and having an accommodating recession for accommodating the light emitting elements and the lead frame, wherein the lead frames are buried in the case and provided side by side in a longitudinal direction of the case, and the surfaces of the lead frames are arranged coplanar, the light emitting elements are mounted on the lead frames, and the plurality of lead frames and the case are arranged in a nearly linear symmetric configuration with respect to a central line that bisects the light emitting device in the longitudinal direction, so that no uneven heat distribution takes place.

### BACKGROUND OF THE INVENTION

1. Field of the Invention

The present invention relates to a side view-type light emitting device.

2. Description of the Related Art

Patent Reference 1 shows a side view-type light emitting device (side surface light emitting device) as the thin-type light emitting device adopted in the backlight of liquid crystal display.

In addition, Patent Reference 2 describes a light emitting device comprising a plurality of light emitting elements, a first resin molding that carries the light emitting elements, and a second resin molding that covers the light emitting elements.
Patent Reference 1: Japanese Patent No. 4239509
Patent Reference 2: JP-A-2008-300694

According to the invention described in Patent Reference 1, a plurality of light emitting elements are arranged side-by-side on the same line in the longitudinal direction of the case (package); individual light emitting elements are mounted on the individual lead frames (lead electrodes), respectively, and the heat generated by the individual light emitting elements is transferred through different heat dissipation routes to outside the case, so that the heat transfer route is divided to improve the heat dissipation property.

However, the invention described in Patent Reference 1 has the following problem: because the dimensions and shapes of the individual lead frames as well as their arrangements are asymmetric respect to the case, heat is deviated in the light emitting device so that localized high temperature portions are generated, and, the stress distribution becomes uneven due to the thermal expansion applied on the case.

Consequently, various troubles take place, such as separation of the lead frames buried in the case from the case, separation of the sealing resin filled in the case from the case, separation of the lead frame and the sealing resin from each other, breaking of bonding wires connecting the light emitting elements, etc., resulting in decreasing reliability, which is undesirable.

According to the invention described in Patent Reference 2, a lead frame is arranged as a base at the center of the first resin molding as a package, and a plurality of light emitting elements is carried en bloc on the base; each light emitting device is formed by arranging an individual lead frame containing a base and a first resin molding as well as a second resin molding facing each other to prevent uneven heat distribution in the light emitting device.

However, when the invention of Patent Reference 2 is adopted in a side view-type light emitting device, in order to enable escape of the heat of the base arranged at the center to the outer side, it is necessary to connect a hanger lead or other heat dissipation dedicated lead frame protruding to the outer side to the base, yet the heat dissipation dedicated lead frame protruding to the outer side hampers the effort to form a thinner and smaller light emitting device, which is undesirable.

In addition, as a plurality of light emitting elements is mounted on the base arranged at the center, the heat dissipation route cannot be divided, and the heat dissipation property is hampered, which is undesirable, too.

The object of the present invention is to solve the problems by providing a highly reliable light emitting device that is not prone to failure, can be made thin and small, and has a high heat dissipation property.

### SUMMARY OF THE INVENTION

The present inventors have performed extensive research in order to solve the problems. As a result of the research, the present invention with the following aspects has been reached.

### <First Aspect>

The first aspect relates to a light emitting device including

two or more light emitting elements,

two or more lead frames electrically connected with the light emitting elements, and

a case in a slender flat box shape and having an accommodating recession for accommodating the light emitting elements and the lead frame;

the light emitting device is a side view-type light emitting device, wherein the light is emitted from the opening portion of the accommodating recession in the side surface direction of the light emitting device;

the lead frames are buried and set side-by-side in the longitudinal direction of the case; the outer surfaces of the lead frames expose from the bottom surface of the accommodating recession; the surfaces of the lead frames and the bottom surface of the accommodating recession are formed flush with each other, and the surfaces of the lead frames are arranged coplanar;

the light emitting elements are mounted on the lead frames arranged at two end portions in a longitudinal direction of the accommodating recession; and

the plurality of lead frames and the case are arranged and formed in a nearly linear symmetric configuration with respect to the central line that bisects the light emitting device in the longitudinal direction.

Consequently, according to the first aspect, the heat generated from the individual light emitting elements can escape to the outer side by conducting through various different heat dissipation routes via individual lead frames. It is possible to improve the heat dissipation property, as the heat dissipation routes are divided from each other.

In addition, as the plurality of lead frames and the case are arranged in a linear symmetric configuration with respect to the central line, it is possible to prevent uneven distribution of heat in the light emitting device, so that no high temperature portion can be generated locally, and the stress applied on the case becomes uniform.

Consequently, various troubles, such as separation of the lead frames buried in the case from the case, separation of the sealing resin filled in the case from the case, separation of the lead frame and the sealing resin from each other, breaking of bonding wires connecting the light emitting elements, etc., can hardly take place, and the reliability is high.

As a result, there is no need to arrange a heat dissipation dedicated lead frame that protrudes from the case to the outer side, so that the light emitting device can be made to have a thin shape and a small size.

### <Second Aspect>

The second aspect relates to the light emitting device according to the first aspect, wherein the plurality of light emitting elements are arranged and formed in a linear symmetric configuration.

Consequently, according to the second aspect, it is possible to have an even distribution of heat in the light emitting device even better than that can be realized according to the first scheme, and the operation and advantage of the first aspect can be realized more reliably.

### <Third Aspect>

The third aspect relates to the light emitting device according to the first or second aspect, wherein three or more lead frames are arranged side-by-side, the lead frames are arranged between the plurality of light emitting elements, and the plurality of light emitting elements are arranged between the light emitting elements and are connected in series via the lead frames.

Consequently, according to the third aspect, when the light emitting elements are connected by bonding wires, different from the case when the light emitting elements are directly connected with each other by the bonding wires without through the lead frames, it is possible to decrease the length of the individual bonding wires, enabling it to further improve the reliability.

### <Fourth Aspect>

The fourth aspect relates to the light emitting device according to the first through third aspects, wherein a column-shaped part is arranged protruding on the inner side surface of the case and [in each gap] between the plurality of light emitting elements.

Consequently, according to the fourth aspect, the stress of concentration held between the light emitting elements as the heating source can be relaxed by the column-shaped parts, so that the operation and advantage of the first aspect can be realized reliably.

### <Fifth Aspect>

The fifth aspect relates to the light emitting device according to the fourth aspect, wherein the column-shaped parts cover the outer surface of the lead frames.

Consequently, according to the fifth aspect, separation of the lead frames from the case can be prevented by the column-shaped parts.

### <Sixth Aspect>

The sixth aspect relates to the light emitting device according to the fourth or fifth aspect, wherein there are bonding wires for connecting the light emitting elements and the lead frames, and the accommodating recession and the column-shaped parts are formed in a shape surrounding along the bonding wires.

As a result, according to the sixth aspect, the bonding wires where a high current flows are protected by the accommodating recession and the column-shaped parts, so that it is possible to prevent wire breakage of the bonding wires, and hence it is possible to further improve reliability.

### BRIEF DESCRIPTION OF THE DRAWINGS

FIG. 1: FIG. 1(A) is an oblique view of the light emitting device 10 of Embodiment 1 of the present invention as viewed from the side surface direction. FIG. 1(B) is an oblique view of the light emitting device 10 as viewed from the side surface direction on the back side.

FIG. 2: FIG. 2(A) is a plane view of the light emitting device 10 as viewed from the side surface direction on the light emitting side. FIG. 2(B) is a lateral cross-sectional view illustrating the light emitting device 10, and it is a cross-sectional view taken across X-X in FIG. 2(A).

FIG. 3: FIG. 3(A) is a plane view of the light emitting device 100 in Embodiment 2 of the present invention as viewed from the side surface direction on the light emitting side. FIG. 3(B) is a lateral cross-sectional view illustrating the light emitting device 100, and it is a cross-sectional view taken across X-X in FIG. 3(A).

FIG. 4: FIG. 4(A) is a plane view of the light emitting device 200 in Embodiment 3 of the present invention. FIG. 4(B) is a lateral cross-sectional view illustrating the light emitting device 200, and it is a cross-sectional view taken across X-X in FIG. 4(A).

FIG. 5: FIG. 5(A) is a plane view of light emitting device 300 in Embodiment 4 of the present invention. FIG. 5(B) is a lateral cross-sectional view illustrating the light emitting device 300, and it is a cross-sectional view taken across X-X in FIG. 5(A).

### DESCRIPTION OF THE PREFERRED EMBODIMENTS

The embodiments of the present invention will be explained in the following sections with reference to the drawings. The same keys are adopted in the various embodiments to represent the some structural members and elements, so they will not be explained repeatedly.

### Embodiment 1

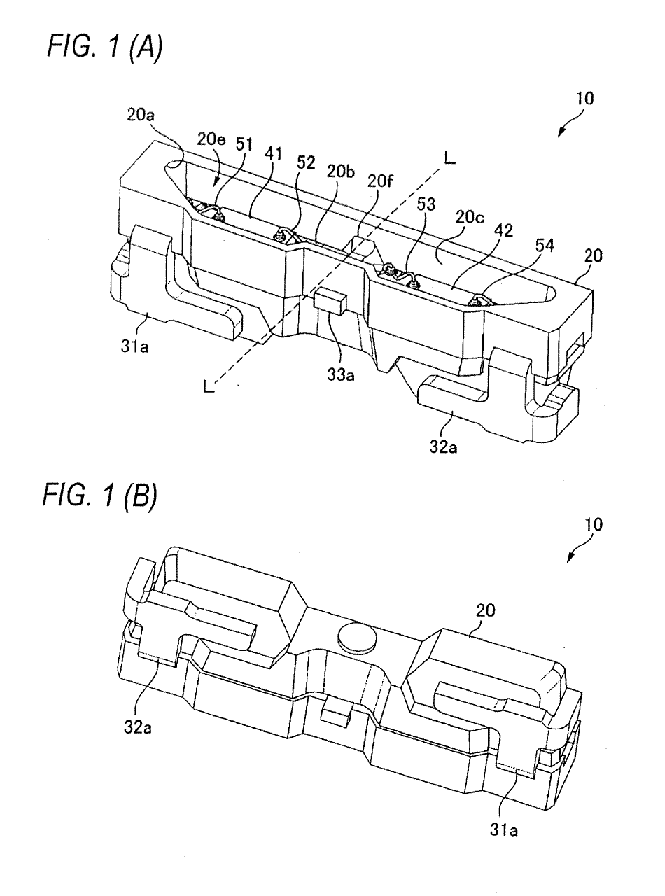

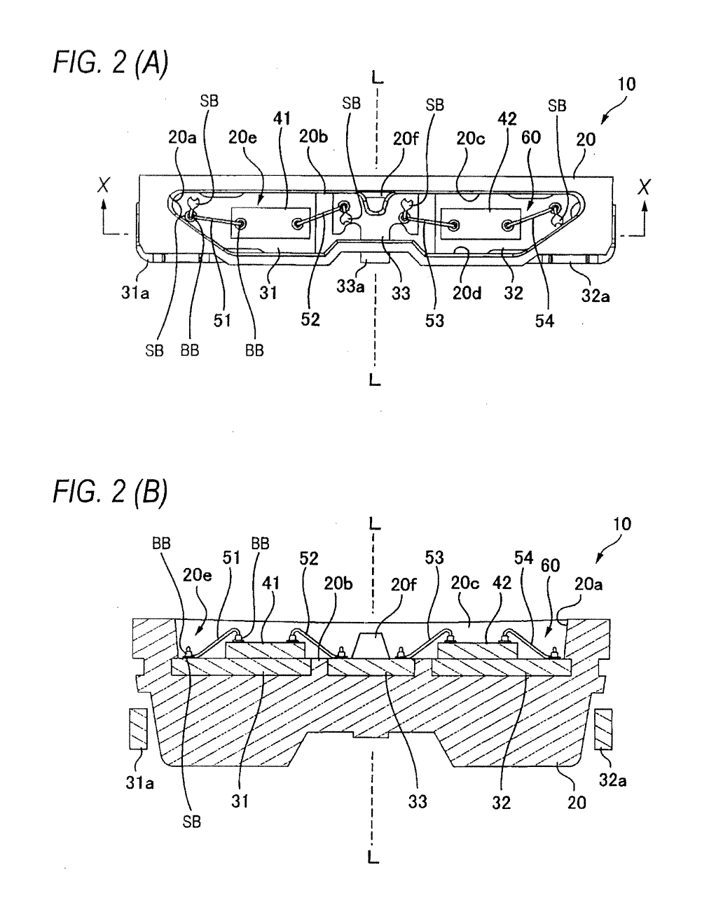

As shown in FIGS. 1 and 2, the light emitting device 10 in Embodiment 1 includes a case 20 (including an opening portion 20a, a bottom surface 20b, inner side surfaces 20c, 20d, an accommodating recession 20e, and a column-shaped part 20f), lead frames 31 to 33, light emitting elements 41, 42, bonding wires 51 to 54, a sealing resin 60, etc. It is a side view-type light emitting device that emits light in the side surface direction (side surface light emitting device).

The light emitting device 10 has a slender flat shape. With respect to the central line (reference line) L that bisects the longitudinal direction, the members excluding the bonding wires 51 to 54 (the case 20, the lead frames 31 to 33, and the light emitting elements 41, 42) are arranged and formed in a linear symmetric configuration.

The case (package) 20 has a slender flat box shape, and it is formed monolithically by injection molding of a synthetic resin. The side surface of the case 20 becomes the opening portion 20a that is fully opened for emitting light. The space surrounded by the inner side surfaces 20c, 20d facing each other in the lateral direction of the case 20, and the bottom surface 20b becomes the accommodating recession 20e, and, on the inner side surface 20c, the column-shaped part 20f is formed as a protrusion.

The width in the lateral direction (the distance between the inner side surfaces 20c, 20d) in the accommodating recession 20e of the case 20 is formed such that the central portion is a slightly narrower, and the two end portions are formed tapering narrower outward.

The lead frames 31 to 33, the light emitting elements 41, 42, and the bonding wires 51 to 54 are accommodated in the accommodating recession 20e of the case 20.

The lead frames 31 to 33 are formed from a metal sheet by pressing processing. When the case 20 is subjected to injection molding, the frames 31 to 33 are insert-molded so that the frames 31 to 33 are buried in the case 20 and are arranged side-by-side in the longitudinal direction of the case 20.

The lead frames 31, 32 have their dimensions, shapes and configuration such that the frames 31 to 33 are linear-symmetric with respect to the central line L.

The lead frame 33 is arranged on the central line L in the longitudinal direction of the case 20, and it is set between the light emitting elements 41, 42.

The outer surfaces of the lead frames 31 to 33 are shown (exposed) from the bottom surface of the accommodating recession 20e (the bottom surface 20b of the case 20 exposed to the interior of the accommodating recession 20e).

The outer surfaces of the lead frames 31 to 33 are formed flush with the bottom surface of the accommodating recession 20e, and the outer surfaces of the lead frames 31 to 33 are arranged coplanar with each other.

The terminal portions 31a, 32a that are exposed from the bottom surface of the accommodating recession 20e and extending from the outer surface of the lead frames 31, 32 are formed on the lead frames 31, 32.

The terminal portions 31a, 32a of the lead frames 31, 32 extend outward from the case 20 and are folded to form the external connection terminal of the light emitting device 10.

In addition, a portion 33a of the lead frame 33 protrudes out from the case 20. It is merely the trace left after cutting of the lead frames 31 to 33 after insert-molding of the lead frames 31 to 33 in the case 20 while they are in the connected state by the connecting members (not shown in the drawing).

The light emitting elements 41, 42 with the same constitution are carried and anchored on the outer surfaces of the lead frames 31, 32, so that they are carried (assembled).

For example, the light emitting elements 41, 42 are made of LED bare chips.

The light emitting elements 41, 42 are in a flat quadratic prism shape, and their upper surfaces form the plus side electrode (not shown in the drawing) and the minus side electrode (not shown in the drawing).

The light emitting elements 41, 42 are connected in series by means of the lead frames 31 to 33 and the bonding wires 51 to 54.

That is, by means of the wire bonding method, the plus side electrode of the light emitting device 41 and the outer surface of the lead frame 31 are connected with each other by the bonding wire 51, and the outer surface of the minus side electrode of the light emitting device 41 and the outer surface of the lead frame 33 are connected with each other by the bonding wire 52. The plus side electrode of the second sealing member 42 and the outer surface of the lead frame 33 are connected with each other by the bonding wire 53, and the minus side electrode of the light emitting device 42 and the outer surface of the lead frame 32 are connected with each other by the bonding wire 54.

That is, the light emitting elements 41, 42 are connected with each other by the lead frame 33 and bonding wires 52, 53.

Here, the bonding wires 51 to 54 are jointed to the lead frames 31 to 33 as they have security bonds.

That is, when the bonding wires 51 to 54 and the lead frames 31 to 33 are connected with each other, first of all, they are jointed by forming stitch bond SB, and then, ball bond BB is formed on the stitch bond SB. Then, the stitch bond SB is formed for jointing at the tips of the bonding wires led out from the ball bond BB.

The column-shaped part 20f is arranged on the central line L at the central portion in the longitudinal direction of the case 20. The lower end side of the column-shaped part 20f is in contact with the outer surface of the lead frame 33, and it covers a portion of the outer surface of the lead frame 33.

The height of the column-shaped part 20f of the case 20 is formed smaller than the depth of the accommodating recession 20e (the distance between the opening portion 20a and the bottom surface 20b), so that the tip side of the column-shaped part 20f does not protrude outside the case 20 from the opening portion 20a.

The light emitting elements 41, 42 are arranged on the same line in the longitudinal direction of the case 20, and they are accommodated in the widest portion in the lateral direction of the accommodating recession 20e of the case 20. The distances from light emitting device 41 to the inner side surfaces 20c, 20d are equal to the distances from the light emitting device 42 to the inner side surfaces 20c, 20d, respectively.

The bonding wires 51 to 54 are accommodated in the two end portions in the longitudinal direction of the accommodating recession 20e of the case 20.

That is, the two end portions in the longitudinal direction of the accommodating recession 20e of the case 20 are formed in the shape along the bonding wires 51, 54 and surrounding them.

The bonding wires 52, 53 are arranged in the central narrow-width portion in the longitudinal direction of the accommodating recession 20e of the case 20, and they are accommodated on the two sides of the column-shaped part 20f, respectively.

That is, the central portion in the longitudinal direction of the accommodating recession 20e and the column-shaped part 20f of the case 20 are formed in a shape along the bonding wires 52, 53 and surrounding them.

The interior of the accommodating recession 20e of the case 20 is filled with a transparent sealing resin 60. Here, the sealing resin 60 seals the articles accommodated in the accommodating recession 20e (lead frames 31 to 33, light emitting elements 41, 42, and bonding wires 51 to 54).

### Operation and Advantages of Embodiment 1

The operation and advantages of the light emitting device 10 in Embodiment 1 are as follows.

(1) The lead frames 31 to 33 are arranged side-by-side in the longitudinal direction of the case 20 and are buried there. The outer surfaces of the lead frames 31 to 33 are exposed from the bottom surface of the accommodating recession 20e, and the outer surfaces of the lead frames 31 to 33 are formed flush with the bottom surface of the accommodating recession 20e, and the surfaces of the lead frames 31 to 33 are arranged coplanar with each other.

The light emitting elements 41, 42 are carried in the lead frames 31, 32 arranged in the two end portions in the longitudinal direction of the case 20. The lead frames 31 to 33, the case 20 and the light emitting elements 41, 42 are formed in a linear symmetric configuration with respect to the central line L that bisects the longitudinal direction of the light emitting device 10.

In other words, the center of gravity is in agreement with the central line L, as viewed from the planar side (the side indicated by arrow X-X shown in FIG. 2(A)) for projection obtained by projecting to the side surface (the surface as shown in FIG. 2(A)) the various elements that form the light emitting device 10 (case 20, lead frames 31 to 33, and light emitting elements 41, 42).

Consequently, the heat generated by the light emitting elements 41, 42 is transferred through different heat dissipation routes via the lead frames 31 to 33, and escapes outside the case 20. It is possible to improve the heat dissipation property, as the heat dissipation routes can be divided.

Because the lead frames 31 to 33, the case 20, and light emitting elements 41, 42 are arranged as linear symmetric with respect to the central line L, it is possible to prevent uneven distribution of the heat in the light emitting device 10, so that no high temperature portion can be generated locally in the light emitting device. As a result, the stress caused by thermal expansion applied on the case 20 becomes uniform.

Consequently, it hardly causes troubles, such as separation of the lead frames 31 to 33 buried in the case 20 from the case 20, separation of the sealing resin 60 filled in the case 20 from the case 20, separation of the lead frames 31 to 33 from the sealing resin 60, wire breakage of the bonding wires 51 to 54 connecting the light emitting elements 41, 42, etc., enabling it to improve reliability.

As a result, there is no need to arrange a heat dissipation dedicated lead frame protruding out from the case 20, so that the light emitting device 10 can be formed in a thin shape and small size.

Various members (lead frames 31 to 33, case 20, and light emitting elements 41, 42) may not be arranged strictly in linear symmetric configuration with respect to the central line L. For example, one may also adopt a structure in which cathode marks are arranged so that they have little contribution to heat dissipation and stress concentration. As a result, even when the various members are formed in a slightly asymmetric configuration, almost the same effects as those explained above can be realized.

In other words, as long as the effects are not hampered, the members may also be arranged and formed in an asymmetric configuration with respect to the central line L.

That is, the lead frames 31 to 33, the case 20, and the light emitting elements 41, 42 may be arranged and formed nearly in a linear symmetric configuration with respect to the central line L so that no uneven distribution of heat takes place.

(2) The lead frame 33 is arranged between the light emitting elements 41, 42, and the light emitting elements 41, 42 are connected in series via the lead frame 33.

Consequently, compared with the case when the light emitting elements 41, 42 are directly connected with each other without via the lead frame 33 and by only a single bonding wire, it is possible to shorten the length of the bonding wires 52, 53, and it is possible to prevent wire breakage, further improving reliability.

(3) Because the column-shaped part 20f is formed protruding to the inner side surface 20c of the case 20 between the light emitting elements 41, 42, the stress on the sealing resin 60 concentrated and sandwiched between the light emitting elements 41, 42 as the heating source can be relaxed by the column-shaped part 20f, so that the operation and advantages of (1) can be realized reliably.

(4) Separation of the lead frame 33 from the case 20 can be prevented by the column-shaped part 20f, as the column-shaped part 20f covers the outer surface of the lead frame 33.

(5) The accommodating recession 20e and the column-shaped part 20f of the case 20 are formed in a shape along the bonding wires 51 to 54 and surrounding the wires.

Consequently, the bonding wires 51 to 54 where high current flows can be protected by the accommodating recession 20e and the column-shaped part 20f, and it is possible to prevent wire breakage of the bonding wires 51 to 54, so that the reliability can be further improved.

### Second Embodiment

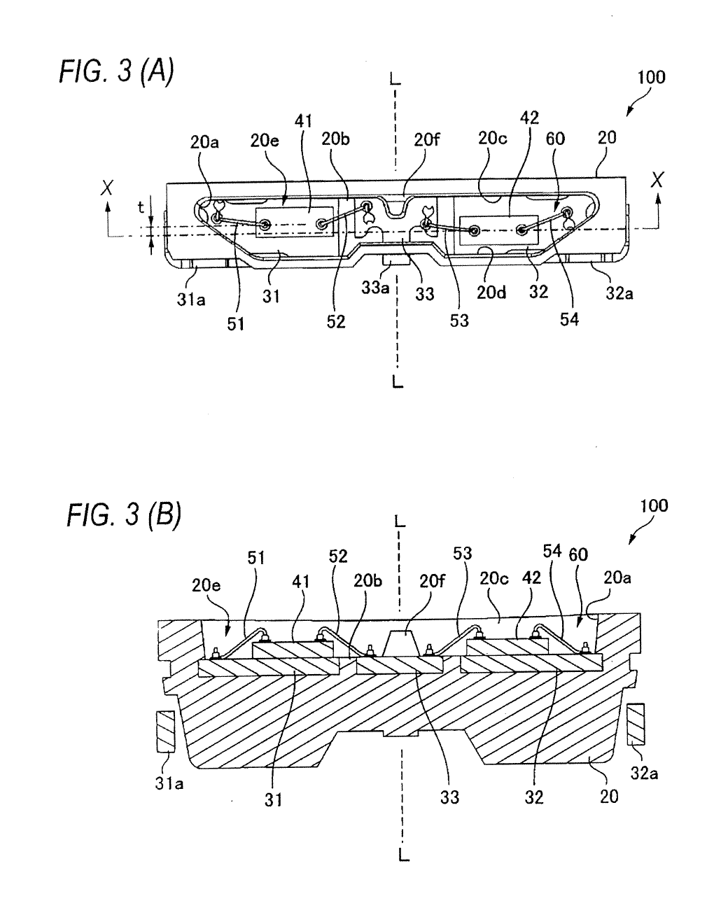

As shown in FIG. 3, the light emitting device 100 of Embodiment 2 is a side view-type light emitting device including the case 20 (opening portion 20a, bottom surface 20b, inner side surfaces 20c, 20d, accommodating recession 20e, and column-shaped part 20f), lead frames 31 to 33, light emitting elements 41, 42, bonding wires 51 to 54, sealing resin 60, etc.

The case 20 in Embodiment 2 is the same as the case 20 in Embodiment 1. Consequently, the oblique view of the light emitting device 100 is similar to the light emitting device 10 in Embodiment 1 as shown in FIG. 1.

Embodiment 2 differs from Embodiment 1 in that the light emitting elements 41, 42 are not arranged in a linear asymmetric configuration with reference to the central line L, and the distance from the light emitting device 41 to the inner side surface 20c of the case 20 is shorter than the distance from the light emitting device 42 and the inner side surface 20c.

That is, in Embodiment 2, the light emitting device 41 is arranged at a site near the inner side surface 20c of the case, and the light emitting device 42 is arranged at a site near the inner side surface 20c of the case.

In Embodiment 2, just as in Embodiment 1, the outer surfaces of the lead frames 31 to 33 are formed flush with the bottom surface of the accommodating recession 20e, and the outer surfaces of the lead frames 31 to 33 are arranged coplanar with each other.

In Embodiment 2, when the light emitting device 100 is viewed in the longitudinal direction, the light emitting elements 41, 42 are arranged superposed with each other in the lateral direction of the light emitting device 100.

More specifically, distance t between the centers of the light emitting elements 41, 42 is set at about 100 μm.

Consequently, in Embodiment 2, where the light emitting elements 41, 42 are arranged in a linear symmetric configuration with respect to the central line L, the same operation and advantages as those of (1) of Embodiment 1 can be realized.

Also, in Embodiment 2, in addition to the case when the light emitting elements 41, 42 are intentionally arranged deviated from each other, the following aspects may also be adopted: the aspect in which deviation in position takes place when the light emitting elements 41, 42 are arranged and bonded on the lead frames 31 to 33, and the aspect in which deviation in position takes place for the light emitting elements 41, 42 due to dimensional error in the various members that form the light emitting device 100.

### Embodiment 3

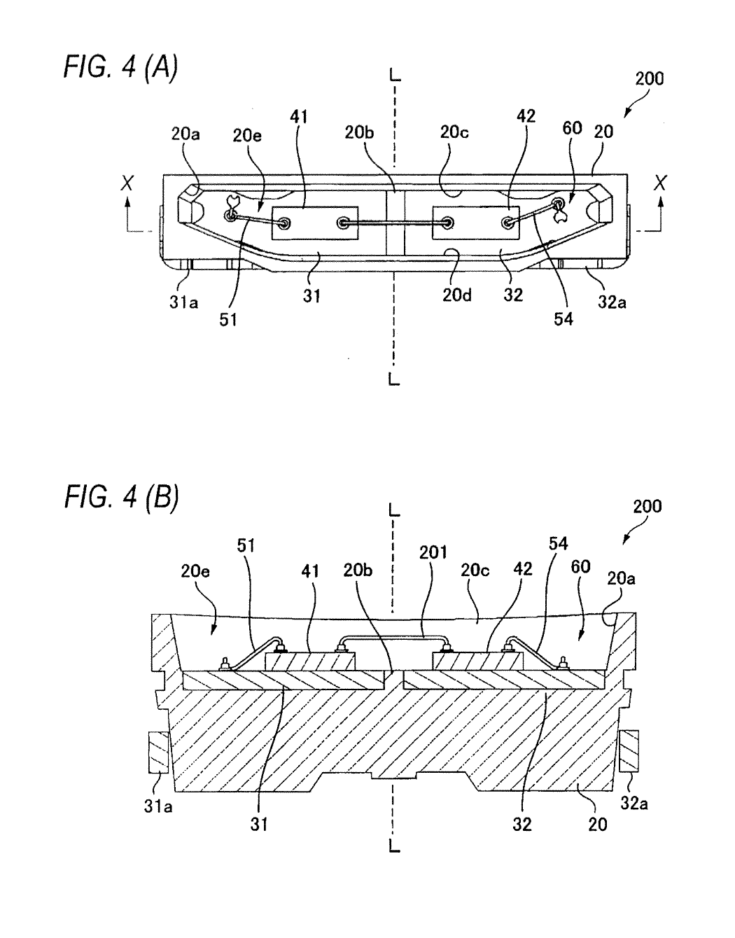

As shown in FIG. 4, the light emitting device 200 of Embodiment 3 is a side view-type light emitting device including a case 20 (opening portion 20a, bottom surface 20b, inner side surfaces 20c, 20d, accommodating recession 20e, and column-shaped part 20f), lead frames 31 to 33, light emitting elements 41, 42, bonding wires 51, 54, 201, sealing resin 60, etc.

In Embodiment 3, the case 20 is the same as the case 20 of Embodiment 1. Consequently, the oblique view of the light emitting device 200 is nearly the same as the light emitting device 10 in Embodiment 1 shown in FIG. 1.

Embodiment 3 differs from Embodiment 1 in the following features.

[a] It does not have the lead frame 33 and the bonding wires 52, 53.

[b] The light emitting elements 41, 42 are directly connected with the bonding wire 201 without via lead frames.

[c] It does not have the column-shaped part 20f.

Consequently, Embodiment 3 can also have the same operation and advantages as those of (1) of Embodiment 1.

### Embodiment 4

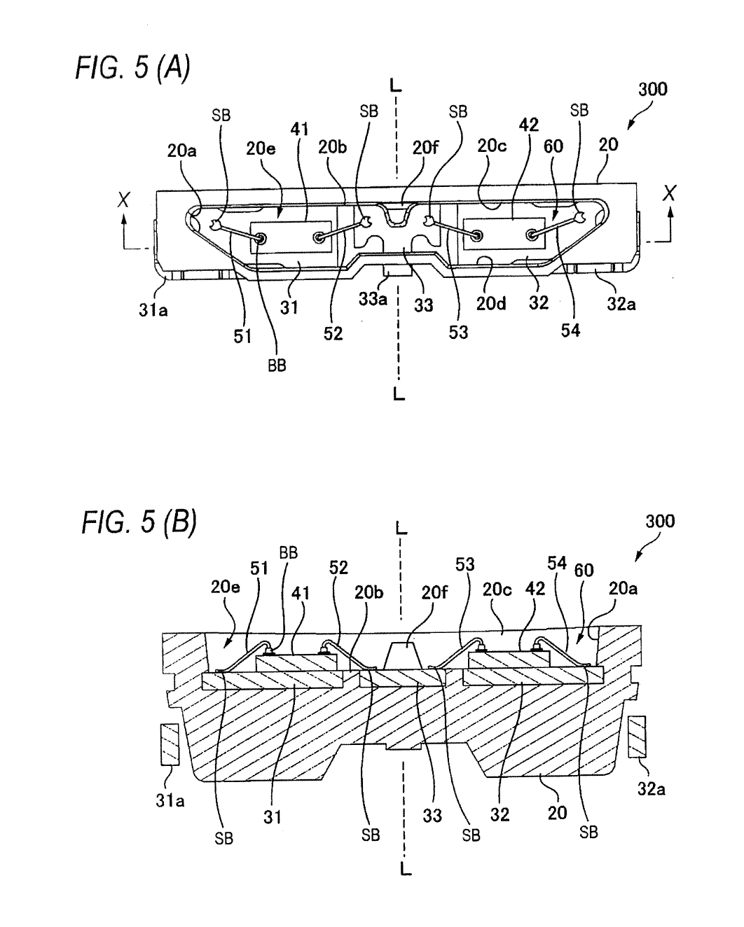

As shown in FIG. 5, the light emitting device 300 of Embodiment 4 is a side view-type light emitting device that emits light in the side surface direction and comprises the following parts: a case 20 (opening portion 20a, bottom surface 20b, inner side surfaces 20c, 20d, accommodating recession 20e, and column-shaped part 20f), lead frames 31 to 33, light emitting elements 41, 42, bonding wires 51 to 54, sealing resin 60, etc.

The case 20 in Embodiment 4 is the same as the case 20 in Embodiment 1. Consequently, the oblique view of the light emitting device 300 is almost the same as the light emitting device 10 of Embodiment 1 shown in FIG. 1.

Embodiment 4 differs from Embodiment 1 in the following features.

(d) For bonding wires 51 to 54, instead of jointing with lead frames 31 to 33 by having security bonds, the bonding wires 51 to 54 are jointed to the lead frames 31 to 33 merely with the stitch bond SB.

(e) All of the members (case 20, lead frames 31 to 33, and light emitting elements 41, 42) including the bonding wires 51 to 54 are arranged and formed in a linear symmetric configuration with respect to the central line L.

Consequently, in addition to the operation and advantages of Embodiment 1, Embodiment 4 also has the following operation and advantages.

(6) Because the heat distribution in the light emitting device 300 and the stress on the sealing resin 60 are linear-symmetric with respect to the central line L, no load is applied on the bonding wires 51 to 54, and wire breakage still can hardly take place, although there is no security bond.

(7) Because there is no security bond, different from Embodiment 1, it is possible to reduce the wire length of the bonding wires 51 to 54, so that it is possible to reduce the cost, and it is possible to decrease the lead time.

### Other Embodiments

The present invention is not limited to the embodiments. One may also adopt the following schemes, and, in this case, the same or better operation and advantages as the embodiments can be realized.

[A] The light emitting elements 41, 42 can also be connected with the lead frames 31 to 33 even when the flip chip method is adopted.

[B] Three or more light emitting elements 41, 42 may be arranged. In this case, it is possible to use the lead frames 31 to 33 with the same number as that of the light emitting elements 41, 42.

[C] The column-shaped part 20f of the inner side surface 20c of the case 20 is not arranged. Instead, a column-shaped part similar to the column-shaped part 20f is arranged protruding on the inner side surface 20d of the case 20. In this case, too, the same operation and advantages as those in [3] to [5] of Embodiment 1 can be realized.

While the column-shaped part 20f of the inner side surface 20c of the case 20 is kept there, a column-shaped part similar to the column-shaped part 20f is also arranged protruding on the inner side surface 20d of the case 20. In this case, it is possible to realize the operation and effects of [3] to [5] of Embodiment 1 more reliably.

Moreover, a column-shaped part that connects between the inner side surfaces 20c, 20d of the case 20 may also be arranged and protruded; in such case, it is possible to further realize the operation and advantages of [3] to [5] of Embodiment 1 more reliably.

[D] The embodiments may be combined and executed, and, in this case, the operations and advantages of the embodiments can all be realized.

The present invention is not limited to the aspects and the embodiments. As long as the description of the claims is observed, various modified aspects may be adopted in the range that can be reached easily by the person skilled in the art. The contents of the papers, patent applications, published patents, etc. described clearly in the present specification are cited here by adopting the contents thereof.

1. Alight emitting device, comprising:
two or more light emitting elements;
two or more lead frames electrically connected to the light emitting elements; and
a case formed as a slender flat box shape and having an accommodating recession for accommodating the light emitting elements and the lead frame;
wherein the light emitting device includes a side view-type light emitting device in which light is emitted from an opening portion of the accommodating recession in a side surface direction of the light emitting device;
wherein the lead frames are buried in the case and provided side by side in a longitudinal direction of the case so that surfaces of the lead frames are exposed from a bottom surface of the accommodating recession, the surfaces of the lead frames and the bottom surface of the accommodating recession are formed flush with each other, and the surfaces of the lead frames are arranged coplanar;
the light emitting elements are mounted on the lead frames arranged at two end portions in a longitudinal direction of the accommodating recession; and
the plurality of lead frames and the case are arranged in a nearly linear symmetric configuration with respect to a central line that bisects the light emitting device in the longitudinal direction.

2. The light emitting device according to claim 1, wherein the plurality of light emitting elements are arranged in a linear symmetric configuration.

3. The light emitting device according to claim 1, wherein three or more lead frames are provided side-by-side, the lead frames are arranged between the plurality of light emitting elements, and the plurality of light emitting elements are connected in series via at least one of the lead frames arranged between the light emitting elements.

4. The light emitting device according to claim 1, further comprising:
a column-shaped part protruding from an inner side surface of the case between the plurality of light emitting elements.

5. The light emitting device according to claim 4, wherein the column-shaped parts cover the surface of the lead frames.

6. The light emitting device according to claim 4, further comprising bonding wires for connecting the light emitting elements and the lead frames,
wherein the accommodating recession and the column-shaped parts are formed in a shape surrounding along the bonding wires.
